(19) United States
(12) Patent Application Publication
(10) Pub. No.: US 2019/0007318 A1
(43) Pub. Date: Jan. 3, 2019

(54) TECHNOLOGIES FOR INFLIGHT PACKET COUNT LIMITING IN A QUEUE MANAGER ENVIRONMENT

(71) Applicant: Intel Corporation, Santa Clara, CA (US)

(72) Inventors: Niall D. McDonnell, Limerick (IE); William Burroughs, Macungie, PA (US); Nitin N. Garegrat, Chandler, AZ (US); David P. Sonnier, Austin, TX (US)

(21) Appl. No.: 15/638,728

(22) Filed: Jun. 30, 2017

(51) Int. Cl. H04L 12/803; H04L 12/859; H04L 12/801; H04L 12/805; H04L 12/863

(52) U.S. Cl. CPC H04L 47/125; H04L 47/2475; H04L 47/623; H04L 47/36; H04L 47/35

(57) ABSTRACT

Technologies for inflight packet count limiting include a network device. The network device is to receive a packet from a producer application. The packet is configured to be enqueued into a packet queue as a queue element to be consumed by a consumer application. The network device is also to increment, in response to receipt of the packet, an inflight count variable, determine whether a value of the inflight count variable satisfies an inflight count limit, and enqueue, in response to a determination that the value of the inflight count variable satisfies the inflight count limit, the packet.

### BACKGROUND

Systems for enabling multiple worker applications to operate on a set of data packets typically prepare queues, such as first in first out (FIFO) queues, that store pointers to the data packets and provide packets from the individual queues to each worker application as queue elements. The worker applications are typically assigned to various cores of a processor of a system. Each queue is independent, meaning each queue is allocated its own set of memory, and each worker application operates on its own copy of the queue. The queues are implemented in memory by a queue manager. The memory storage is controlled using a credit scheme whereby each worker application is assigned a certain number of credits.

Worker applications spend credits when enqueueing (or producing) packets to the queue, and earn credits when dequeueing (or consuming) packets from the queue. This approach tends to cause at least two credit loop scenarios where one or more worker applications run out of credits because their consuming does not release sufficient credit to meet their producing needs. In one scenario, packets are subject to packet multiplication where each subsidiary packet, when produced to the queue, results in a credit being expended. In another scenario, if a first application produces a packet that is then consumed by a second application, the first application does not earn back the credit it spent, which may, over time, lead to the first application running out of credits.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system that includes a network device for inflight packet count limiting in a queue manager environment;

FIG. 2 is a simplified block diagram of at least one embodiment of a network device of the system of FIG. 1;

FIG. 3 is a simplified block diagram of at least one embodiment of an environment that may be established by the network device of FIGS. 1 and 2;

FIG. 4 is a simplified flow diagram of at least one embodiment of a method for inflight packet count limiting that may be performed by the network device of FIGS. 1 and 2;

FIGS. 5 and 6 are a simplified flow diagram of at least one embodiment of a method for implementing a count decrement control scheme that may be performed by the network device of FIGS. 1 and 2; and

FIGS. 7 and 8 are a simplified flow diagram of at least one embodiment of a method for limiting an inflight packet count in a packet multiplication scenario that may be performed by a worker application.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

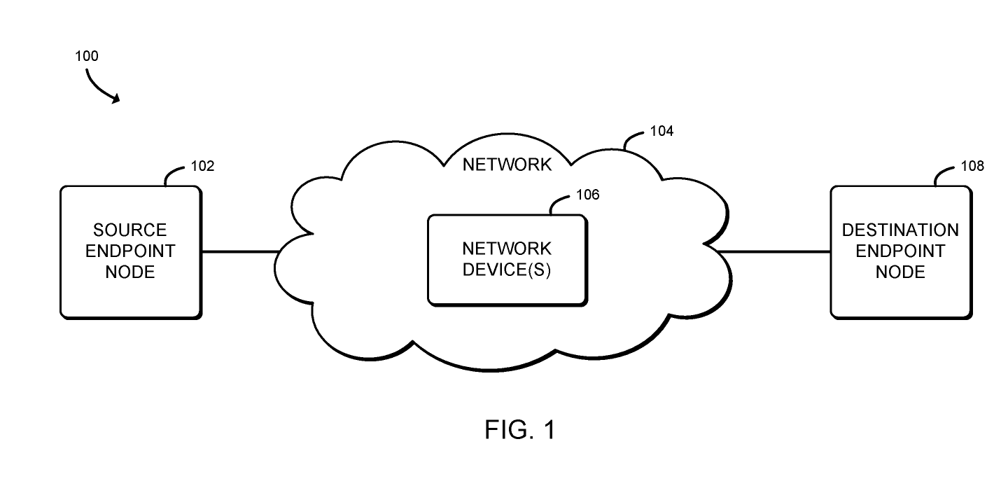

Referring now to FIG. 1, in an illustrative embodiment, a system 100 for inflight limiting of data packets in a queue manager environment includes a source endpoint node 102 and a destination endpoint node 108 in communication over a network 104 via one or more network devices 106. In use, the network device 106 limits the number of packets that are inflight (e.g., the number of packets that can be queued by one or more worker applications) between the source endpoint node 102 and the destination endpoint node 108 over the network 104.

In networking, data packets (or packets) may traverse a number of applications, also referred to herein as worker applications. In at least some implementations, a queue manager queues these packets based on the priority and ordering requirements of the tasks and associated packets. In packet processing applications, individual cores may do part of the overall task and pass packets to succeeding cores. These cores are may be referred to as ‘workers’ or ‘agents’. A worker may both consume and produce packets for processing. The queue manager may be implemented via hardware and referred to as a hardware queue manager (HQM). The HQM may be embodied as a system of queues that links worker applications, some of which will consume a packet from a queue (i.e., dequeue the packet from the queue), whereas others will produce a packet (i.e., enqueue the packet into the queue). In some embodiments, the HQM implements the queue in memory. In such embodiments, the memory is accessed using a credit scheme where each worker is assigned a share of the internal storage. In some embodiments, this share is represented as a number of credits. Accordingly, an application spends a credit when producing a packet for the queue (i.e., adding the packet to the memory of the queue) and earns a credit back when consuming a packet from the queue (i.e., removing a packet from the queue and processing the packet). In at least some implementations, each worker application is treated as equal, resulting in a scenario where a worker application may rely on consuming packets just to obtain credit with which to produce packets for enqueueing. This scenario is referred to herein as a credit loop. The technologies disclosed herein allow for the ability to avoid deadlocks caused due to credit loops.

As described in more detail herein, the illustrative network device 106 utilizes a hardware queue manager (HQM) and allocates cores of one or more processors of the network device 106 to process packets that are produced for and consumed from one or more queues. A packet is also referred to herein as a queue element. The HQM receives data packets from a network interface controller (NIC), which may also be referred to as a host fabric interface (HFI), of the network device 106 (i.e., data packets from the source endpoint node 102). Each packet includes metadata defining properties of the data packet. Worker applications, as described above, consume packets from the queue and perform operations on the metadata and data packets, such as compressing, decompressing, encrypting, or decrypting packet data and/or adding, removing, or modifying headers. Worker applications additionally may modify the metadata to indicate a status of the packet, such as whether a particular process has completed and/or whether the data packet is ready for processing by another worker application.

The source endpoint node 102 may be embodied as any type of computation or computing device capable of performing the functions described herein, including, without limitation, a computer, a desktop computer, a smartphone, a workstation, a laptop computer, a notebook computer, a tablet computer, a mobile computing device, a wearable computing device, a network appliance, a web appliance, a distributed computing system, a processor-based system, and/or a consumer electronic device. Similarly, the destination endpoint node 108 may be embodied as any type of computation or computing device capable of performing the functions described herein, including, without limitation, a computer, a desktop computer, a smartphone, a workstation, a laptop computer, a notebook computer, a tablet computer, a mobile computing device, a wearable computing device, a network appliance, a web appliance, a distributed computing system, a processor-based system, and/or a consumer electronic device. Each of the source endpoint node 102 and the destination endpoint node 108 may include components commonly found in a computing device such as a processor, memory, input/output subsystem, data storage, communication circuitry, etc.

The network 104 may be embodied as any type of wired or wireless communication network, including cellular networks (e.g., Global System for Mobile Communications (GSM), 3G, Long Term Evolution (LTE), Worldwide Interoperability for Microwave Access (WiMAX), etc.), digital subscriber line (DSL) networks, cable networks (e.g., coaxial networks, fiber networks, etc.), telephony networks, local area networks (LANs) or wide area networks (WANs), global networks (e.g., the Internet), or any combination thereof. Additionally, the network 104 may include any number of network devices 106 as needed to facilitate communication between the source endpoint node 102 and the destination endpoint node 108.

Each network device 106 may be embodied as any type of computing device capable of facilitating wired and/or wireless network communications between the source endpoint node 102 and the destination endpoint node 108. For example, each network device 106 may be embodied as a server (e.g., stand-alone, rack-mounted, blade, etc.), a router, a switch, a network hub, an access point, a storage device, a compute device, a multiprocessor system, a network appliance (e.g., physical or virtual), a computer, a desktop computer, a smartphone, a workstation, a laptop computer, a notebook computer, a tablet computer, a mobile computing device, or any other computing device capable of processing network packets.

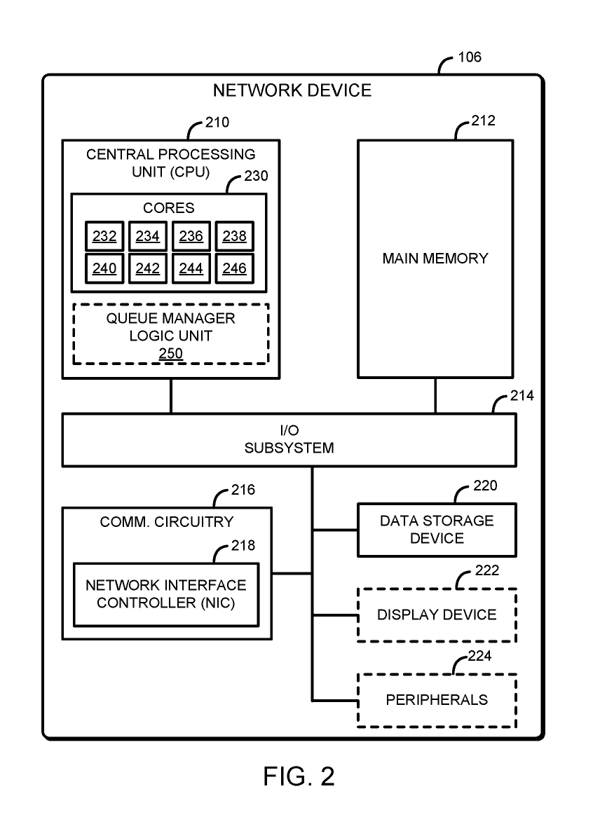

As shown in FIG. 2, an illustrative network device 106 includes a central processing unit (CPU) 210, a main memory 212, an input/output (I/O) subsystem 214, and communication circuitry 216. Of course, in other embodiments, the network device 106 may include other or additional components, such as those commonly found in a computer (e.g., data storage, display, etc.). Additionally, in some embodiments, one or more of the illustrative components may be incorporated in, or otherwise form a portion of, another component. For example, in some embodiments, the main memory 212, or portions thereof, may be incorporated in the CPU 210.

The CPU 210 may be embodied as any type of processor capable of performing the functions described herein. The CPU 210 may be embodied as a single or multi-core processor(s), a microcontroller, or other processor or processing/controlling circuit. In some embodiments, the CPU 210 may be embodied as, include, or be coupled to a field programmable gate array (FPGA), an application specific integrated circuit (ASIC), a graphics processing unit (GPU), reconfigurable hardware or hardware circuitry, or other specialized hardware to facilitate performance of the functions described herein. In the illustrative embodiment, the CPU 210 is embodied as a processor containing a set 230 of multiple cores 232, 234, 236, 238, 240, 242, 244, and 246. While eight cores are shown in FIG. 2, it should be understood that in other embodiments, the CPU 210 may contain a different number of cores. Similarly, the main memory 212 may be embodied as any type of volatile (e.g., dynamic random access memory (DRAM), etc.) or non-volatile memory or data storage capable of performing the functions described herein. In some embodiments, all or a portion of the main memory 212 may be integrated into the CPU 210. In operation, the main memory 212 may store various data and software used during operation of the network device 106 such as packet data, operating systems, applications, programs, libraries, and drivers.

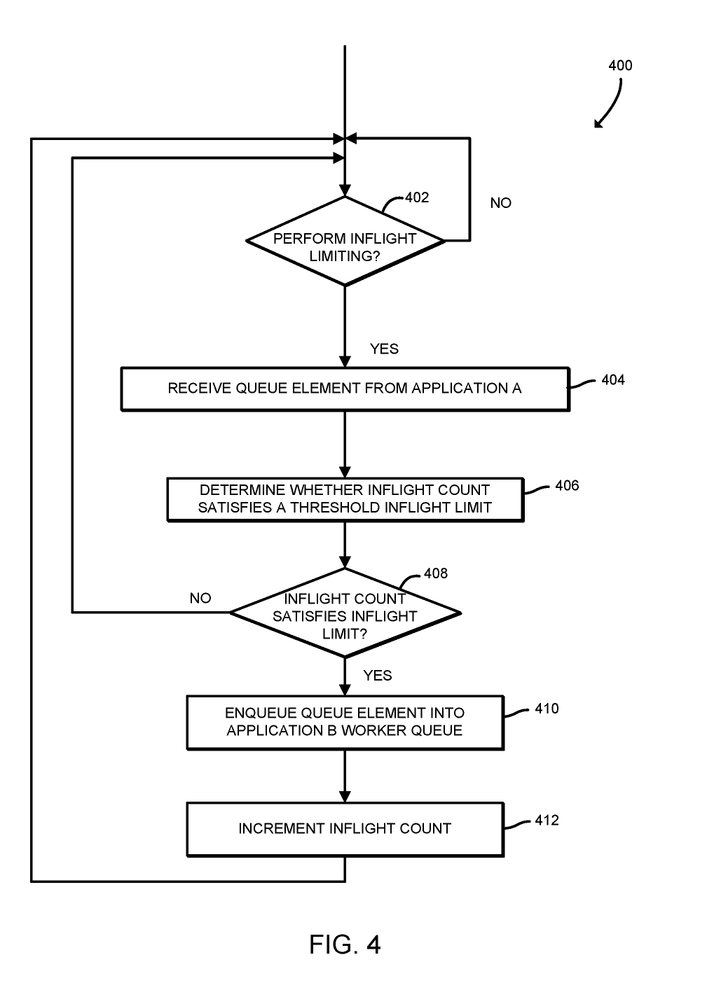

In addition, the CPU 210, in the illustrative embodiment, also includes a queue manager logic unit 250. The queue manager logic unit 250 may be embodied as any hardware device (e.g., a co-processor, an FPGA, and ASIC, or circuitry) capable of performing functions that include inflight limiting of data packets in a queue environment. More specifically, the queue manager logic unit 250 is any device capable of performing the inflight packet count limiting scheme described with respect to FIGS. 4-8 below.

The I/O subsystem 214 may be embodied as circuitry and/or components to facilitate input/output operations with the CPU 210, the main memory 212, and other components of the network device 106. For example, the I/O subsystem 214 may be embodied as, or otherwise include, memory controller hubs, input/output control hubs, integrated sensor hubs, firmware devices, communication links (i.e., point-to-point links, bus links, wires, cables, light guides, printed circuit board traces, etc.), and/or other components and subsystems to facilitate the input/output operations. In some embodiments, the I/O subsystem 214 may form a portion of a system-on-a-chip (SoC) and be incorporated, along with one or more of the CPU 210, the main memory 212, and other components of the network device 106, on a single integrated circuit chip.

The communication circuitry 216 may be embodied as any communication circuit, device, or collection thereof, capable of enabling communications over the network 104 between the network device 106 and the source endpoint node 102, another network device 106, and/or the destination endpoint node 108. The communication circuitry 216 may be configured to use any one or more communication technology (e.g., wired or wireless communications) and associated protocols (e.g., Ethernet, Bluetooth®, Wi-Fi®, WiMAX, etc.) to effect such communication.

The illustrative communication circuitry 216 includes a network interface controller (NIC) 218, which may also be referred to as a host fabric interface (HFI). The NIC 218 may be embodied as one or more add-in-boards, daughtercards, network interface cards, controller chips, chipsets, or other devices that may be used by the network device 106 to connect the source endpoint node 102, the destination endpoint node 108, and/or another network device 106. In some embodiments, the NIC 218 may be embodied as part of a system-on-a-chip (SoC) that includes one or more processors, or included on a multichip package that also contains one or more processors. In some embodiments, the NIC 218 may include a local processor (not shown) and/or a local memory (not shown) that are both local to the NIC 218. In such embodiments, the local processor of the NIC 218 may be capable of performing one or more of the functions of the CPU 210 described herein. Additionally or alternatively, in such embodiments, the local memory of the NIC 218 may be integrated into one or more components of the network device 106 at the board level, socket level, chip level, and/or other levels.

The network device 106 may additionally include a data storage device 220, which may be embodied as any type of device or devices configured for short-term or long-term storage of data such as, for example, memory devices and circuits, memory cards, hard disk drives, solid-state drives, or other data storage devices. The data storage device 220 may include a system partition that stores data and firmware code for the network device 106. The data storage device 220 may also include an operating system partition that stores data files and executables for an operating system of the network device 106.

Additionally, the network device 106 may include a display 222. The display 222 may be embodied as, or otherwise use, any suitable display technology including, for example, a liquid crystal display (LCD), a light emitting diode (LED) display, a cathode ray tube (CRT) display, a plasma display, and/or other display usable in a compute device. The display may include a touchscreen sensor that uses any suitable touchscreen input technology to detect the user's tactile selection of information displayed on the display including, but not limited to, resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors. Additionally or alternatively, the network device 106 may include one or more peripheral devices 224. Such peripheral devices 224 may include any type of peripheral device commonly found in a compute device such as speakers, a mouse, a keyboard, and/or other input/output devices, interface devices, and/or other peripheral devices. It should be appreciated that the network device 106 may include other components, sub-components and/or devices commonly found in a network device, which are not illustrated in FIG. 2 for clarity of the description.

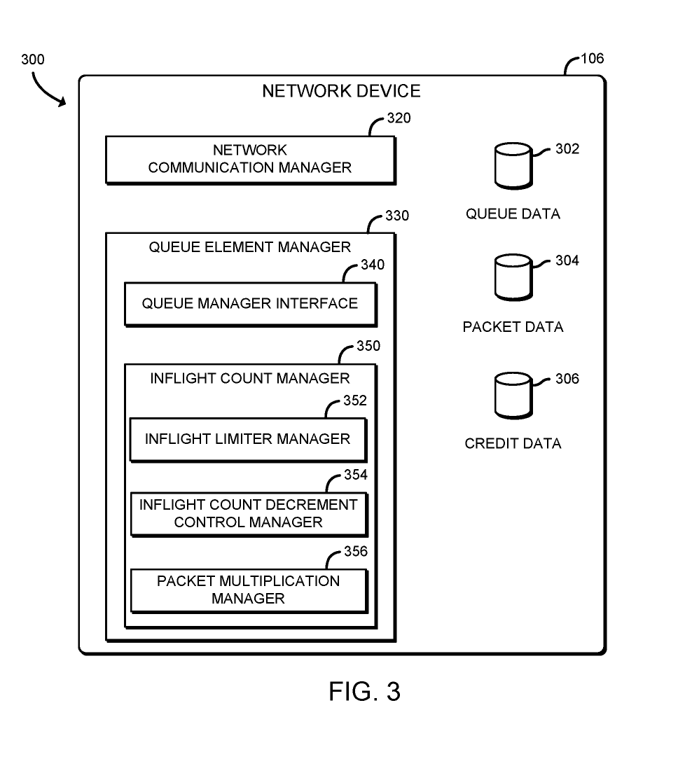

Referring now to FIG. 3, in the illustrative embodiment, each network device 106 may establish an environment 300 during operation. The illustrative environment 300 includes a network communication manager 320 and a queue element manager 330 that includes a queue manager interface 340 and an inflight count manager 350. Each of the components of the environment 300 may be embodied as hardware, firmware, software, or a combination thereof. As such, in some embodiments, one or more of the components of the environment 300 may be embodied as circuitry or collection of electrical devices (e.g., network communication circuitry 320, queue element management circuitry 330, queue manager interface circuitry 340, inflight count manager circuitry 350, etc.). It should be appreciated that, in such embodiments, one or more of the network communication circuitry 320, queue element management circuitry 330, queue manager interface circuitry 340, or inflight count manager circuitry 350 may form a portion of one or more of the CPU 210, main memory 212, I/O subsystem 214, communication circuitry 216 and/or other components of the network device 106. Additionally, in some embodiments, one or more of the illustrative components may form a portion of another component and/or one or more of the illustrative components may be independent of one another. Further, in some embodiments, one or more of the components of the environment 300 may be embodied as virtualized hardware components or emulated architecture, which may be established and maintained by the CPU 210 or other components of the network device 106.

In the illustrative environment 300, the network device 106 also includes queue data 302, packet data 304, and credit data 306. The queue data 302 may be embodied as any data that is indicative of one or more queues that are managed by the queue element manager 330 (e.g., the HQM). The queue data 302, in the illustrative embodiment, as also includes data indicative of queue elements (e.g., packets) that are enqueued and/or dequeued from the one or more queues, queue status, and producer and consumer worker applications presently associated with each queue. The packet data 304 may be embodied as any data that is indicative of packet payloads, packet source and destination information, and packet metadata. The metadata defines properties of a packet, such as the packet size, an input port number, an output port number, and state data that is indicative of which worker applications have completed processing of the data packet and whether the data packet is ready for transmission to another device (e.g., to the destination endpoint node 108). In some embodiments, the metadata also includes data indicative of whether the packet is subject to multiplication or fragmentation during processing. The packet data 304, in the illustrative embodiment, also includes data indicative of the contents of the data packets received and operated on by the various worker applications assigned to the cores 230. As such, the packet data 304 includes headers, payload data, and/or other information initially included in a data packet and/or information added to or modified in the data packet as a result of processing by the worker applications. The credit data 306 may be embodied as any data usable to manage the credit status of the various worker applications executed by the cores 230 in the network device 106. For example, a worker application A may be represented in the credit data 306 as having a maximum possible number of credits, no credits, or a non-zero number of credits that is less than the maximum. The credit data 306, in the illustrative embodiment, also includes data indicative of maximum credit counts and/or a maximum credit weight assigned (e.g., in a packet multiplication scenario). The queue data 302, packet data 304, and credit data 306 may be accessed by the various components and/or sub-components of the network device 106.

The network communication manager 320, which may be embodied as hardware, firmware, software, virtualized hardware, emulated architecture, and/or a combination thereof as discussed above, is configured to facilitate inbound and outbound network communications (e.g., network traffic, network packets, network flows, etc.) to and from the network device 106, respectively. To do so, the network communication manager 320 is configured to receive and process data packets from one computing device (e.g., the source endpoint node 102, another network device 106, the destination endpoint node 108) and to prepare and send data packets to another computing device (e.g., the source endpoint node 102, another network device 106, the destination endpoint node 108). Accordingly, in some embodiments, at least a portion of the functionality of the network communication manager 320 may be performed by the communication circuitry 216, and, in the illustrative embodiment, by the NIC 218.

The queue element manager 330, which may be embodied as hardware, firmware, software, virtualized hardware, emulated architecture, and/or a combination thereof as discussed above, is configured to manage one or more packet queues in the memory 212 of the network device 106, assign the cores 230 of the CPU 210 to one or more worker applications for a packet, and manage concurrent access of the worker applications to the one or more queues. To do so, in the illustrative embodiment, the queue element manager 330 includes the queue manager interface 340 and the inflight count manager 350. Worker applications produce packets for enqueueing into a queue as other worker applications consume packets from the queue, with the queue manager interface 340 managing the enqueue and dequeue processes. The queue element manager 330 may be implemented by the queue manager logic unit 250 of FIG. 2, and is configured to perform the functions of the hardware queue manager (HQM).

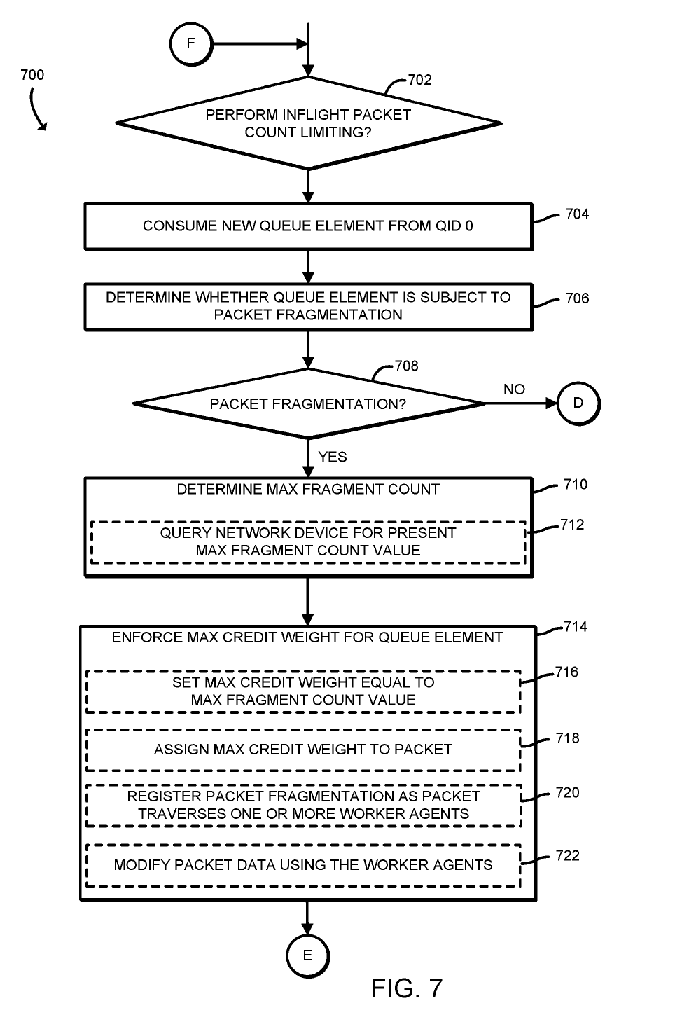

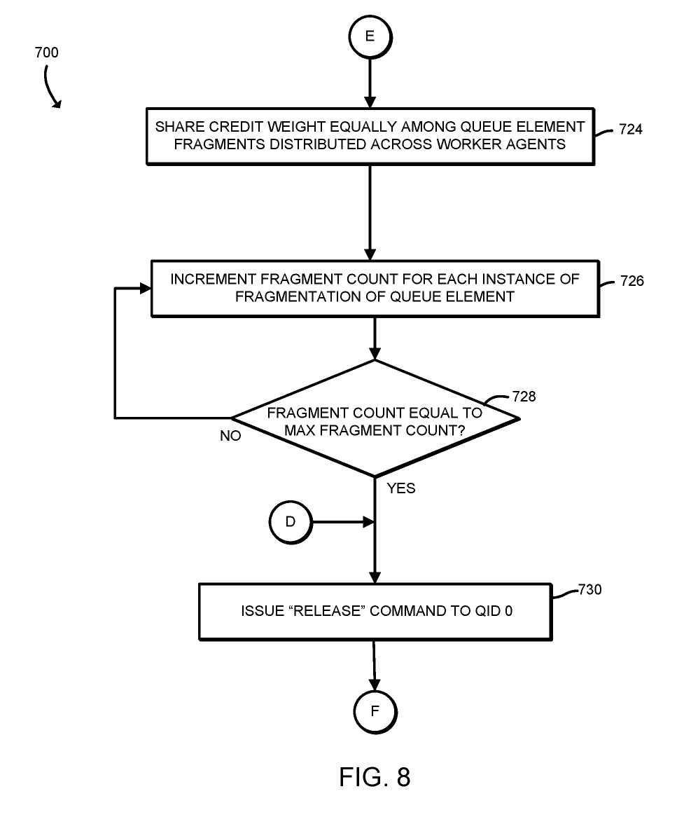

The inflight count manager 350, which may be embodied as hardware, firmware, software, virtualized hardware, emulated architecture, and/or a combination thereof as discussed above, is configured to limit the number of packets that are inflight across the various queues managed by the queue manager interface 340. To do so, the illustrative inflight count manager 350 includes an inflight limiter manager 352, an inflight count decrement control manager 354, and a packet multiplication manager 356. The inflight count decrement control manager 354, in the illustrative embodiment, is configured to perform a decrement control scheme as described in further detail with respect to FIGS. 4-6. In the illustrative embodiment, the inflight count decrement control manager 354 prevents decrementing of the packet count even if a worker application has consumed a packet from a queue. By preventing decrement of the packet count, the inflight count decrement control manager 354 prevents the credit count for the worker application from falling to zero. The packet multiplication manager 356, in the illustrative embodiment, is configured to perform inflight packet count limiting in a packet multiplication scenario as described in further detail with respect to FIGS. 7 and 8.

It should be appreciated that each of the inflight limiter manager 352, the inflight count decrement control manager 354, and the packet multiplication manager 356 may be separately embodied as hardware, firmware, software, virtualized hardware, emulated architecture, and/or a combination thereof. For example, the inflight limiter manager 352 may be embodied as a hardware component, while the inflight count decrement control manager 354 and the packet multiplication manager 356 are embodied as virtualized hardware components or as some other combination of hardware, firmware, software, virtualized hardware, emulated architecture, and/or a combination thereof.

Referring now to FIG. 4, in use, the network device 106 may execute a method 400 for inflight packet count limiting. In the illustrative embodiment, the method(s) of FIGS. 4-8 are governed by an Equation 1 as shown below:

CREDITS>MAX_INJ*MAX_CHILD+(AGENTS−1)*HWM Equation 1.

wherein CREDITS is the allocation of credits to a worker application, MAX_INJ is a limit on the number of packets that can be injected into the queue, MAX_CHILD is a limit on the number of child packets that can be spawned from a single packet, AGENTS is the number of worker applications (i.e., worker application agents) executed by the network device 106, and HWM is a high water mark level. In general, and as indicated by Equation 1, a worker application's credits are kept artificially higher than the number of packets inflight. This is done by controlling MAX_INJ as described below with respect to FIGS. 4-8. More specifically, in the illustrative embodiment, the network device 106, in operation, may vary the point at which the inflight packet count is decremented, allowing control of the number of packets inflight at any time.

The method 400 begins with block 402, in which the network device 106 determines whether to perform the inflight limiting scheme. In the illustrative embodiment, the network device 106 may determine to perform the inflight limiting scheme in response to determining that the queue manager logic unit 250 is present, in response to a determination that a setting stored in a configuration file in the data storage device 220 indicates to perform the inflight limiting scheme, and/or as a function of other criteria. Regardless, in response to a determination to perform the inflight limiting scheme, the method 400 advances to block 404 in which the network device 106 receives a packet from a worker application. As an example, an application A will produce a packet that is to be enqueued into a queue by the network device 106. In response to receipt of the queue element, the network device 106 determines whether an inflight packet count satisfies a threshold inflight limit, as indicated in block 406. More specifically, a threshold inflight limit is set for a number of data packets that may be inflight (e.g., being sent and received by one or more queues managed by the network device 106). For example, the threshold inflight limit may represent a maximum number of packets that can be enqueued, or a maximum number of packets that can be transacted across all worker applications, or a maximum number of packets that can be received from the cache during a given time period. The threshold inflight limit may also be represented as a minimum, a floor value, a ceiling value, a range, or any numerical formulation capable of serving as a comparison or threshold point for the number of packets being managed by the network device 106.

In block 408, the network device 106 determines the subsequent operations to perform as a function of whether the inflight count satisfies the threshold inflight limit. In determining whether the inflight count satisfies the threshold inflight limit, the network device 106 may determine whether the inflight count is less than the threshold inflight limit. If the inflight count does not satisfy the threshold inflight limit, the method returns to block 402, and the network device 106 again determines whether to perform the inflight limiting scheme. However, if the threshold inflight limit is satisfied, the method 400 advances to block 410, in which the network device 106 proceeds to enqueue the packet into a queue. In one embodiment, another worker application may consume the packet and perform operations on the packet. For example, in block 410, the network device 106 enqueues the packet into a worker application queue. From this worker application queue, another application B (e.g., “application B”) may consume the packet and process it. The method 400 subsequently proceeds to block 412 in which the network device 106 increments the inflight count. Afterwards, the method 400 returns to the block 402, in which the network device 106 determines whether to continue performing the inflight limiting scheme.

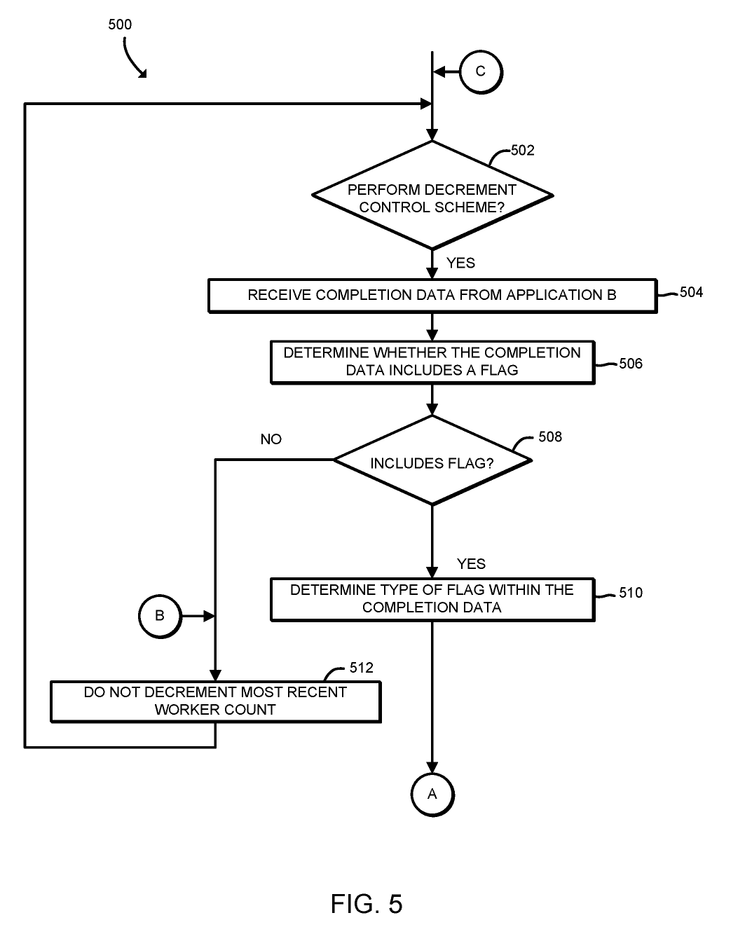

Referring now to FIG. 5, in use, the network device 106 may execute a method 500 for performing a decrement control scheme. In the illustrative embodiment, the network device 106 is configured to prevent an inflight count from being decremented under certain conditions. Preventing the inflight count from being decremented blocks the queue from releasing new packets. This has the effect of minimizing the number of packets ‘inflight’ within the system beyond the queue.

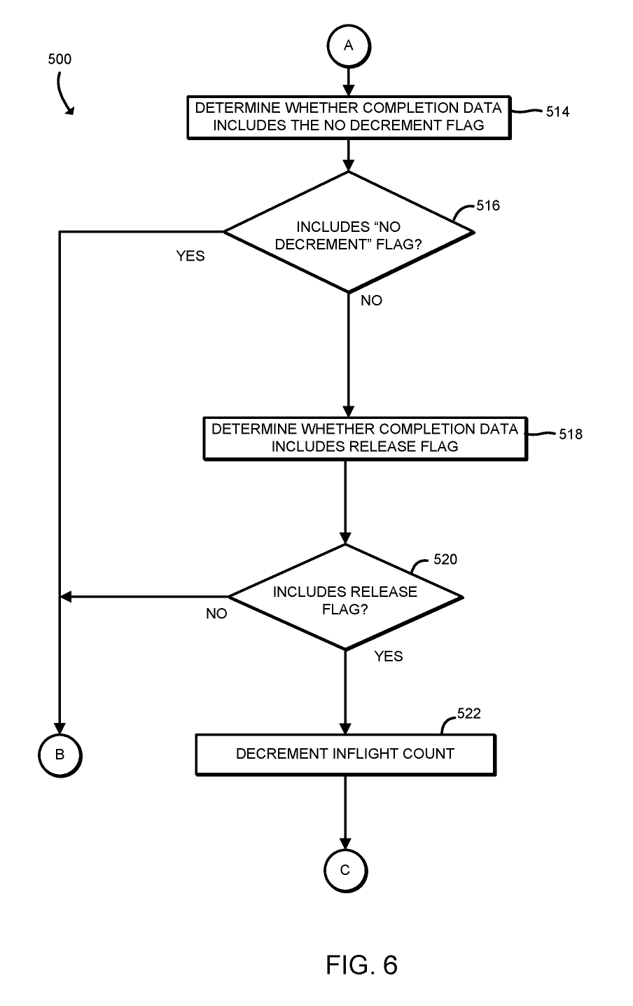

The method 500 begins at block 502, in which the network device 106 determines whether to perform the decrement control scheme. In the illustrative embodiment, the network device 106 may determine to perform the decrement control scheme in response to determining that the queue manager logic unit 250 is present, in response to a determination that a setting stored in a configuration file in the data storage device 220 indicates to perform the decrement control scheme, and/or as a function of other criteria. The method 500 advances to block 504, in which the network device 106 receives completion data from an application, referred to in the illustrative embodiment as application B. As used herein, completion data refers to any data produced by a worker application that indicates that the worker application has completed processing on a packet. In the illustrative embodiment, worker application B provides completion data to the network device 106. The completion data indicates that worker application B has completed processing on a packet that worker application B previously consumed from a queue managed by the network device 106. The method 500 then advances to block 506, in which the network device 106 determines whether the completion data includes a flag. The flag may be embodied as any data indicative of whether to decrement the inflight count and/or whether to indicate to the network device 106 that the packet is being released by worker application B, as described in greater detail with respect to FIG. 6.

If it is determined in block 508 that the completion data includes a flag, the method 500 advances to block 510. In block 510, the network device 106 determines the type of flag within the completion data. In the illustrative embodiment, the flag may be a release flag or a no decrement flag as described in greater detail with respect to FIG. 6. If it is determined that the completion data does not include a flag at all, the method 500 advances to block 512 where the network device 106 determines to decrement the packet count for the most recent queue. As used herein, the most recent queue is the internal queue from which the packet was most recently consumed. In the illustrative embodiment, the network device 106 retains an identifier of the most recent queue when it consumed a packet. If the no decrement flag is determined to be within the completion data, then the most recent queue's packet count is not decremented. In other words, the inflight count is maintained at its previous level, even though application B has indicated completion of processing on a packet. Afterwards, the method 500 loops back to block 502, in which the network device 106 again determines whether to perform the decrement control scheme. In addition, a release flag is directed at the specific queue that was targeted by the worker application that provided the completion data.

Referring now to FIG. 6, and continuing from block 510, the method 500 advances to block 514, in which the network device 106 determines whether the completion data includes the no decrement flag. If, in block 516, the network device 106 determines that the completion data includes the no decrement flag, the method 500 returns to block 512 of FIG. 5, in which the network device 106 determines not to decrement the inflight count as described above. If the completion data does not include the no decrement flag, the method 500 advances to block 518, in which the network device 106 determines whether the completion data includes the release flag. Referring now to block 520, if the network device 106 determined that the completion data does not include the release flag, the method 500 returns to block 512 of FIG. 5, in which the network device 106 determines to not decrement the inflight count, as described above. In the case of release, the method 500 advances to block 522. In block 522, the network device 106 decrements the inflight count. More specifically, in the illustrative embodiment, the inflight count is decremented (e.g., by one unit) and the value is updated in memory. Additionally, since the inflight count is decremented, application B's credits may also be decremented proportionately. Subsequently, the method 500 loops back to block 502 of FIG. 5, in which the network device 106 determine whether to continue performing the decrement control scheme.

Referring now to FIG. 7, in operation, a worker application (e.g., worker application A or worker application B as described above with respect to FIGS. 4 and 5) executed by the network device 106 may perform a method 700 to limit an inflight packet count in a packet multiplication scenario. It should be understood that, as the network device 106 executes the worker applications, a description herein of a worker application performing an operation refers to the network device 106 performing the operation during the execution of the corresponding worker application. As shown in FIG. 7, the method 700 begins at block 702 in which the worker application determines whether to perform limiting of the inflight packet count in a packet multiplication scenario, such as by reading a configuration file and determining whether the configuration file includes an indication to limit the inflight packet count in a packet multiplication scenario. In other embodiments, the worker application may make the determination based on other factors. Regardless, in response to a determination to perform limiting of the inflight packet count, the method 700 advances to block 704, in which the worker application consumes a packet from a queue managed by network device 106. In the illustrative embodiment, the packet is as described above with respect to FIGS. 4 and 5. The packet has been enqueued by another worker application as a queue element into a queue managed by the network device 106.

Subsequently, the method 700 advances to block 706, in which the worker application determines whether the packet is subject to packet fragmentation. In the illustrative embodiment, the network device 106 adopts a pessimistic approach that presumes that every packet is subject to packet fragmentation. More specifically, in the illustrative embodiment, the worker application queries the packet data 304 to determine whether the packet is subject to packet fragmentation. As used herein, packet fragmentation refers to a property of a packet whereby, to process the packet, the packet is distributed into one or more sub-packets. In the illustrative embodiment, each sub-packet is counted as a single packet for purposes of credit management for the worker application. Accordingly, if the worker application completes processing on each sub-packet and enqueues each sub-packet into a queue managed by the network device 106, the worker application may need to spend credits for each sub-packet, rather than just for the single packet that it initially consumed from the queue. Excessive spending of credits due to packet multiplication may lead to the worker application running out of credits. To prevent this, the worker application determines whether the packet will be subject to packet multiplication before processing the packet further. In block 708, if the worker application determines that the packet is subject to packet multiplication, the method 700 advances to block 710. In block 710, the worker application determines a value for the maximum fragment count. As used herein, the maximum fragment count is a value set by the network device 106 to denote the maximum number of sub-packets into which a packet may be fragmented during the course of processing. In the illustrative embodiment, the network device 106 may be provided this value by an operator, may set the value based on prior instances of packet multiplication, may read the value from a configuration file, or may obtain the value from another source. The maximum fragment count may also be chosen based on known traffic and network conditions. Additionally, the network device 106 may be provided data regarding the largest possible packet that can be enqueued, based on, for example, the maximum transmission unit (MTU) size of an egress port for the network device 106.

The method 700 subsequently advances to block 714 in which the worker application enforces a maximum credit weight for the queue element. In the illustrative embodiment, and as indicated in block 716, the worker application sets the maximum credit weight equal to the maximum fragment count determined in block 710. Additionally, in the illustrative embodiment, the worker application assigns the maximum credit weight to the packet, as indicated in block 718. For example, the maximum fragment count may be set by the network device 106 to be 16. Accordingly, in the example, the maximum credit weight assigned to the packet by the worker application will be 16. In the illustrative embodiment, the worker application also registers or records packet fragmentation as the packet traverses through processing, as indicated in block 720. For example, the worker application may have one or more subsidiary worker agents that each operate on a fragment of the packet. Each time a worker agent fragments the packet for processing, the worker application records the instance of packet fragmentation. Additionally, in the illustrative embodiment, the worker application modifies the packet data to denote the packet fragmentation during processing, as indicated in block 722. Subsequently, the method 700 advances to block 724 of FIG. 8, in which the worker application shares the credit weight equally across each of the packet fragments that are distributed across the worker agents.

Referring now to block 726 of FIG. 8, the worker application increments a local fragment count for each instance of fragmentation of the packet. In the illustrative embodiment, each time a worker agent has completed processing of a packet fragment, the worker application increments its local fragment count, rather than sending a release command to the network device 106. The local fragment count continues to increment as the packet is fragmented further. In block 728, the worker application determines whether the local fragment count has reached the value of the maximum fragment count. If the local fragment count has not reached the value of the maximum fragment count, the method 700 loops back to block 726 in which the worker application (i.e., the worker agent(s)) continue to process the packet fragments and increment the local fragment count. If the local fragment count reaches the value of the maximum fragment count, the worker application issues a release command in block 730 to the network device 106 managing the queue. More specifically, the worker application provides completion data to the network device 106. The completion data includes the release flag as described above with respect to blocks 520, 522 of FIG. 6. The release flag indicates to the network device 106 that the worker application's credit can be decremented. After block 730, the method 700 loops back to block 702 of FIG. 7 in which the worker application determines whether to continue limiting the inflight packet count.

### EXAMPLES

Illustrative examples of the technologies disclosed herein are provided below. An embodiment of the technologies may include any one or more, and any combination of, the examples described below.

Example 1 includes a network device to limit an inflight packet count, the network device comprising one or more processors that include a plurality of cores; a network interface controller coupled to the one or more processors; and one or more memory devices having stored therein a plurality of instructions that, when executed by the one or more processors, cause the network device to receive a packet from a producer application, wherein the packet is configured to be enqueued into a packet queue as a queue element to be consumed by a consumer application; increment, in response to receipt of the packet, an inflight count variable; determine whether a value of the inflight count variable satisfies an inflight count limit; and enqueue, in response to a determination that the value of the inflight count variable satisfies the inflight count limit, the packet into the packet queue.

Example 2 includes the subject matter of Example 1, and wherein to receive a packet from the producer application comprises to query a memory address at which the packet was stored by the producer application for retrieval by the network device.

Example 3 includes the subject matter of any of Examples 1 and 2, and wherein the plurality of instructions, when executed by the one or more processors, further cause the network device to decline, in response to a determination that the value of the inflight count variable does not satisfy the inflight count limit, to enqueue the packet as the queue element into a worker agent queue associated with the consumer application.

Example 4 includes the subject matter of any of Examples 1-3, and wherein the plurality of instructions, when executed by the one or more processors, further cause the network device to receive completion data from the consumer application, wherein the completion data is indicative of completion of processing of the packet by the consumer application.

Example 5 includes the subject matter of any of Examples 1-4, and wherein the plurality of network instructions, when executed by the one or more processors, further cause the network device to determine whether the completion data includes a no decrement flag.

Example 6 includes the subject matter of any of Examples 1-5, and wherein the plurality of instructions, when executed by the one or more processors, further cause the network device to decline, in response to a determination that the completion data includes the no decrement flag, to decrement the inflight count variable.

Example 7 includes the subject matter of any of Examples 1-6, and wherein the plurality of instructions, when executed by the one or more processors, further cause the network device to decrement, in response to receipt of a release command, the inflight count variable.

Example 8 includes the subject matter of any of Examples 1-7, and wherein the plurality of instructions, when executed by the one or more processors, cause the network device to execute the consumer application to consume the packet from the packet queue; and generate completion data indicative of completion of processing of the packet by the consumer application.

Example 9 includes the subject matter of any of Examples 1-8, and wherein the plurality of instructions, when executed by the one or more processors, cause the network device to execute the consumer application to detect whether the packet has fragmented into at least one sub-packet; determine, in response to a detection that the packet has fragmented into at least one sub-packet, a maximum fragment count; increment, in response to the detection that the packet has fragmented into at least one sub-packet, a fragment count; determine whether the fragment count satisfies the maximum fragment count; and provide, in response to a determination that the fragment count satisfies the maximum fragment count, completion data to the network device, wherein the completion data is indicative of completion of processing of the packet by the consumer application.

Example 10 includes the subject matter of any of Examples 1-9, and wherein to provide the completion data to the network device comprises to receive a release command indicative of a request to decrement the inflight count variable.

Example 11 includes a method for limiting an inflight packet count, the method comprising receiving, by a network device, a packet from a producer application, wherein the packet is configured to be enqueued into a packet queue as a queue element to be consumed by a consumer application; incrementing, by the network device and in response to receipt of the packet, an inflight count variable; determining, by the network device, whether a value of the inflight count variable satisfies an inflight count limit; and enqueuing, by the network device and in response to a determination that the value of the inflight count variable satisfies the inflight count limit, the packet into the packet queue.

Example 12 includes the subject matter of Example 11, and wherein receiving a packet from the producer application comprises querying a memory address at which the packet was stored by the producer application for retrieval by the network device.

Example 13 includes the subject matter of any of Examples 11 and 12, and further including declining, by the network device and in response to a determination that the value of the inflight count variable does not satisfy the inflight count limit, to enqueue the packet as the queue element into a worker agent queue associated with the consumer application.

Example 14 includes the subject matter of any of Examples 11-13, and further including receiving, by the network device, completion data from the consumer application, wherein the completion data is indicative of completion of processing of the packet by the consumer application.

Example 15 includes the subject matter of any of Examples 11-14, and further including determining, by the network device, whether the completion data includes a no decrement flag.

Example 16 includes the subject matter of any of Examples 11-15, and further including declining, by the network device and in response to a determination that the completion data includes the no decrement flag, to decrement the inflight count variable.

Example 17 includes the subject matter of any of Examples 11-16, and further including decrementing, by the network device and in response to receipt of a release command, the inflight count variable.

Example 18 includes the subject matter of any of Examples 11-17, and further including consuming, by the network device and with the consumer application, the packet from the packet queue; and generating, by the network device and with the consumer application, completion data indicative of completion of processing of the packet by the consumer application.

Example 19 includes the subject matter of any of Examples 11-18, and further including detecting, by the network device, whether the packet has fragmented into at least one sub-packet; determining, by the network device and in response to a detection that the packet has fragmented into at least one sub-packet, a maximum fragment count; incrementing, by the network device and in response to the detection that the packet has fragmented into at least one sub-packet, a fragment count; determining, by the network device, whether the fragment count satisfies the maximum fragment count; and generating, by the network device and in response to a determination that the fragment count satisfies the maximum fragment count, completion data indicative of completion of processing of the packet by the consumer application.

Example 20 includes the subject matter of any of Examples 11-19, and wherein generating the completion data comprises generating completion data that includes a no decrement flag indicative of a request to decline to decrement the inflight count variable.

Example 21 includes one or more machine-readable storage media comprising a plurality of instructions stored thereon that, in response to being executed, cause a network device to perform the method of any of Examples 11-20.

Example 22 includes a network device to limit an inflight packet count, the network device comprising one or more processors that include a plurality of cores; a network interface controller coupled to the one or more processors; and one or more memory devices having stored therein a plurality of instructions that, when executed, cause the network device to perform the method of any of Examples 11-20.

Example 23 includes a network device to limit an inflight packet count, the network device comprising means for performing the method of any of Examples 11-20.

Example 24 includes a network device to limit an inflight packet count, the network device comprising inflight count manager circuitry to receive a packet from a producer application, wherein the packet is configured to be enqueued into a packet queue as a queue element to be consumed by a consumer application, increment, in response to receipt of the packet, an inflight count variable, determine whether a value of the inflight count variable satisfies an inflight count limit, and enqueue, in response to a determination that the value of the inflight count variable satisfies the inflight count limit, the packet into the packet queue.

Example 25 includes the subject matter of Example 24, and wherein to receive a packet from the producer application comprises to query a memory address at which the packet was stored by the producer application for retrieval by the network device.

Example 26 includes the subject matter of any of Examples 24 and 25, and wherein the inflight count manager circuitry is to decline, in response to a determination that the value of the inflight count variable does not satisfy the inflight count limit, to enqueue the packet as the queue element into a worker agent queue associated with the consumer application.

Example 27 includes the subject matter of any of Examples 24-26, and wherein the inflight count manager circuitry is to receive completion data from the consumer application, wherein the completion data is indicative of completion of processing of the packet by the consumer application.

Example 28 includes the subject matter of any of Examples 24-27, and wherein the inflight count manager circuitry is to determine whether the completion data includes a no decrement flag.

Example 29 includes the subject matter of any of Examples 24-28, and wherein the inflight count manager circuitry is to decline, in response to a determination that the completion data includes the no decrement flag, to decrement the inflight count variable.

Example 30 includes the subject matter of any of Examples 24-29, and wherein the inflight count manager circuitry is to decrement, in response to receipt of a release command, the inflight count variable.

Example 31 includes the subject matter of any of Examples 24-30, and wherein the inflight count manager circuitry is to execute the consumer application to consume the packet from the packet queue; and generate completion data indicative of completion of processing of the packet by the consumer application.

Example 32 includes the subject matter of any of Examples 24-31, and wherein the inflight count manager circuitry is to execute the consumer application to detect whether the packet has fragmented into at least one sub-packet; determine, in response to a detection that the packet has fragmented into at least one sub-packet, a maximum fragment count; increment, in response to the detection that the packet has fragmented into at least one sub-packet, a fragment count; determine whether the fragment count satisfies the maximum fragment count; and provide, in response to a determination that the fragment count satisfies the maximum fragment count, completion data to the network device, wherein the completion data is indicative of completion of processing of the packet by the consumer application.

Example 33 includes the subject matter of any of Examples 24-32, and wherein to provide the completion data to the network device comprises to provide completion data that includes a no decrement flag indicative of a request to decline to decrement the inflight count variable.

Example 34 includes a network device to limit an inflight packet count, the network device comprising circuitry for receiving a packet from a producer application, wherein the packet is configured to be enqueued into a packet queue as a queue element to be consumed by a consumer application; means for incrementing, in response to receipt of the packet, an inflight count variable; means for determining whether a value of the inflight count variable satisfies an inflight count limit; and circuitry for enqueueing, in response to a determination that the value of the inflight count variable satisfies the inflight count limit, the packet into the packet queue.

Example 35 includes the subject matter of Example 34, and wherein the circuitry for receiving a packet from a producer application comprises circuitry for querying a memory address at which the packet was stored by the producer application for retrieval by the network device.

Example 36 includes the subject matter of any of Examples 34 and 35, and further including circuitry for declining, in response to a determination that the value of the inflight count variable does not satisfy the inflight count limit, to enqueue the packet as the queue element into a worker agent queue associated with the consumer application.

Example 37 includes the subject matter of any of Examples 34-36, and further including circuitry for receiving completion data from the consumer application, wherein the completion data is indicative of completion of processing of the packet by the consumer application.

Example 38 includes the subject matter of any of Examples 34-37, and further including circuitry for determining whether the completion data includes a no decrement flag.

Example 39 includes the subject matter of any of Examples 34-38, and further including circuitry for declining, in response to a determination that the completion data includes the no decrement flag, to decrement the inflight count variable.

Example 40 includes the subject matter of any of Examples 34-39, and further including circuitry for consuming the packet from the packet queue; and circuitry for generating completion data indicative of completion of processing of the packet by the consumer application.

Example 41 includes the subject matter of any of Examples 34-40, and further including circuitry for detecting whether the packet has fragmented into at least one sub-packet; circuitry for determining, in response to a detection that the packet has fragmented into at least one sub-packet, a maximum fragment count; circuitry for incrementing, in response to the detection that the packet has fragmented into at least one sub-packet, a fragment count; circuitry for determining whether the fragment count satisfies the maximum fragment count; and circuitry for providing, in response to a determination that the fragment count satisfies the maximum fragment count, completion data to the network device, wherein the completion data is indicative of completion of processing of the packet by the consumer application.

Example 42 includes the subject matter of any of Examples 34-41, and wherein the circuitry for providing the completion data to the network device comprises circuitry for receiving a release command indicative of a request to decrement the inflight count variable.

1. A network device to limit an inflight packet count, the network device comprising:
one or more processors that include a plurality of cores;
a network interface controller coupled to the one or more processors; and
one or more memory devices having stored therein a plurality of instructions that, when executed by the one or more processors, cause the network device to:
receive a packet from a producer application, wherein the packet is configured to be enqueued into a packet queue as a queue element to be consumed by a consumer application;
increment, in response to receipt of the packet, an inflight count variable;
determine whether a value of the inflight count variable satisfies an inflight count limit; and
enqueue, in response to a determination that the value of the inflight count variable satisfies the inflight count limit, the packet into the packet queue.

2. The network device of claim 1, wherein to receive a packet from the producer application comprises to query a memory address at which the packet was stored by the producer application for retrieval by the network device.

3. The network device of claim 1, wherein the plurality of instructions, when executed by the one or more processors, further cause the network device to decline, in response to a determination that the value of the inflight count variable does not satisfy the inflight count limit, to enqueue the packet as the queue element into a worker agent queue associated with the consumer application.

4. The network device of claim 1, wherein the plurality of instructions, when executed by the one or more processors, further cause the network device to receive completion data from the consumer application, wherein the completion data is indicative of completion of processing of the packet by the consumer application.

5. The network device of claim 4, wherein the plurality of network instructions, when executed by the one or more processors, further cause the network device to determine whether the completion data includes a no decrement flag.

6. The network device of claim 5, wherein the plurality of instructions, when executed by the one or more processors, further cause the network device to decline, in response to a determination that the completion data includes the no decrement flag, to decrement the inflight count variable.

7. The network device of claim 1, wherein the plurality of instructions, when executed by the one or more processors, further cause the network device to decrement, in response to receipt of a release command, the inflight count variable.

8. The network device of claim 1, wherein the plurality of instructions, when executed by the one or more processors, cause the network device to execute the consumer application to:
consume the packet from the packet queue; and
generate completion data indicative of completion of processing of the packet by the consumer application.

9. The network device of claim 1, wherein the plurality of instructions, when executed by the one or more processors, cause the network device to execute the consumer application to:
detect whether the packet has fragmented into at least one sub-packet;
determine, in response to a detection that the packet has fragmented into at least one sub-packet, a maximum fragment count;
increment, in response to the detection that the packet has fragmented into at least one sub-packet, a fragment count;
determine whether the fragment count satisfies the maximum fragment count; and
provide, in response to a determination that the fragment count satisfies the maximum fragment count, completion data to the network device, wherein the completion data is indicative of completion of processing of the packet by the consumer application.

10. The network device of claim 9, wherein to provide the completion data to the network device comprises to receive a release command indicative of a request to decrement the inflight count variable.

11. One or more machine-readable storage media comprising a plurality of instructions stored thereon that, in response to being executed, cause a network device to:
receive a packet from a producer application, wherein the packet is configured to be enqueued into a packet queue as a queue element to be consumed by a consumer application;
increment, in response to receipt of the packet, an inflight count variable;
determine whether a value of the inflight count variable satisfies an inflight count limit; and
enqueue, in response to a determination that the value of the inflight count variable satisfies the inflight count limit, the packet into the packet queue.

12. The one or more machine-readable storage media of claim 11, wherein to receive a packet from the producer application comprises to query a memory address at which the packet was stored by the producer application for retrieval by the network device.

13. The one or more machine-readable storage media of claim 12, wherein, when executed, the plurality of instructions further cause the network device to decline, in response to a determination that the value of the inflight count variable does not satisfy the inflight count limit, to enqueue the packet as the queue element into a worker agent queue associated with the consumer application.

14. The one or more machine-readable storage media of claim 11, wherein, when executed, the plurality of instructions further cause the network device to receive completion data from the consumer application, wherein the completion data is indicative of completion of processing of the packet by the consumer application.

15. The one or more machine-readable storage media of claim 14, wherein, when executed, the plurality of instructions further cause the network device to determine whether the completion data includes a no decrement flag.

16. The one or more machine-readable storage media of claim 15, wherein, when executed, the plurality of instructions further cause the network device to decline, in response to a determination that the completion data includes the no decrement flag, to decrement the inflight count variable.

17. The one or more machine-readable storage media of claim 11, wherein, when executed, the plurality of instructions further cause the network device to decrement, in response to receipt of a release command, the inflight count variable.

18. The one or more machine-readable storage media of claim 11, wherein, when executed, the plurality of instructions further cause the network device to execute the consumer application to:
consume the packet from the packet queue; and
generate completion data indicative of completion of processing of the packet by the consumer application.

19. The one or more machine-readable storage media of claim 11, wherein, when executed, the plurality of instructions further cause the network device to execute the consumer application to:
detect whether the packet has fragmented into at least one sub-packet;
determine, in response to a detection that the packet has fragmented into at least one sub-packet, a maximum fragment count;
increment, in response to the detection that the packet has fragmented into at least one sub-packet, a fragment count;
determine whether the fragment count satisfies the maximum fragment count; and
provide, in response to a determination that the fragment count satisfies the maximum fragment count, completion data to the network device, wherein the completion data is indicative of completion of processing of the packet by the consumer application.

20. The one or more machine-readable storage media of claim 11, wherein to provide the completion data to the network device comprises to receive a release command indicative of a request to decrement the inflight count variable.

21. A network device to limit an inflight packet count, the network device comprising:
circuitry for receiving a packet from a producer application, wherein the packet is configured to be enqueued into a packet queue as a queue element to be consumed by a consumer application;
means for incrementing, in response to receipt of the packet, an inflight count variable;
means for determining whether a value of the inflight count variable satisfies an inflight count limit; and
circuitry for enqueueing, in response to a determination that the value of the inflight count variable satisfies the inflight count limit, the packet into the packet queue.

22. A method for limiting an inflight packet count, the method comprising:
receiving, by a network device, a packet from a producer application, wherein the packet is configured to be enqueued into a packet queue as a queue element to be consumed by a consumer application;
incrementing, by the network device and in response to receipt of the packet, an inflight count variable;
determining, by the network device, whether a value of the inflight count variable satisfies an inflight count limit; and
enqueuing, by the network device and in response to a determination that the value of the inflight count variable satisfies the inflight count limit, the packet into the packet queue.

23. The method of claim 22, wherein receiving a packet from the producer application comprises querying a memory address at which the packet was stored by the producer application for retrieval by the network device.

24. The method of claim 22, further comprising declining, by the network device and in response to a determination that the value of the inflight count variable does not satisfy the inflight count limit, to enqueue the packet as the queue element into a worker agent queue associated with the consumer application.
